(19) United States
(12) Patent Application Publication
(10) Pub. No.: US 2010/0043002 A1
(43) Pub. Date: Feb. 18, 2010

(54) WORKFLOW HANDLING APPARATUS, WORKFLOW HANDLING METHOD AND IMAGE FORMING APPARATUS

(75) Inventor: Akihiko Fujiwara, Yokohama-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/539,016

(22) Filed: Aug. 11, 2009

Related U.S. Application Data
(60) Provisional application No. 61/088,092, filed on Aug. 12, 2008.

(51) Int. Cl. G06F 9/46

(52) U.S. Cl. 718/102

(57) ABSTRACT

A workflow handling apparatus includes an activity storage unit which stores various activities forming a workflow, a workflow configuration storage unit which stores information about an existing workflow including each of the activities, an information type storage unit which stores data on an information type used in the existing workflow, a request storage unit which stores a new workflow created on the basis of a processing request to the workflow handling apparatus, the new workflow being connected with a processing corresponding to the various activities, an information type determination unit which determines an information type used in the new workflow, a determination unit which determines a degree of similarity between the information type used in the new workflow and the information type used in the existing workflow, and a workflow extraction unit which extracts an existing workflow having the degree of similarity equal to or greater than a predetermined value.

### CROSS-REFERENCE TO RELATED APPLICATION

This application is based upon and claims the benefit of U.S. Provisional Application No. 61/088,092, filed Aug. 12, 2008.

### TECHNICAL FIELD

The present invention relates to a technique of handling a workflow.

### BACKGROUND

In development of software systems, it is necessary to design what processing procedures should be taken to realize user's requests. As this designing technique, an invention described in JP-A-2000-67128 is known which uses a workflow and a use case.

A workflow is a series of processings formed by connecting, in time series, a group of unit processings (hereinafter referred to as activities) constituting a processing. A use case is a request to a system that is realized from the user's perspective.

Meanwhile, the technique described in JP-A-2000-67128 aims at smoothing the processing of a series of duties that does not require complex procedures like seeking “approval by a superior”, among parties concerned.

Therefore, it is difficult to directly apply this technique if there are diverse contents of processings instead of a single processing or if activities need to be selected to form contents of processings.

For example, a processing of using a digital multifunction peripheral or the like to scan a paper document, then form electronic data of the document and analyze a document image is considered.

Page image information acquired by scanning a paper document is formed in various file formats such as bitmap and JPEG. Area information acquired by analyzing the layout configuration of a content of image information includes coordinate information of an area rectangle and information described in PDL (Page Description Language). Area semantic information on a content contained in each area information includes a title area and a header area indicating date. Area semantic information may also include text information that generates as a result of OCR, translated text information as a result of translating text information to another language, and so on.

In such a processing, an enormous number of combinations of information types are required in accordance with user requests that are expressed as use cases. Therefore, to deal with various user needs, proper management of diverse information involved in activities is demanded. Moreover, in a designing technique to analyze a new use case and form a workflow, it is desired that proper activities can easily configured on the basis of such diverse information.

### SUMMARY

According to a first aspect of the invention, a workflow handling apparatus includes: an activity storage unit which stores various activities as processing units forming a workflow; a workflow configuration storage unit which stores information about an existing workflow including each of the activities; an information type storage unit which stores data on an information type used in the existing workflow; a request storage unit which stores a new workflow created on the basis of a processing request to the workflow handling apparatus, the new workflow being connected with a processing corresponding to the various activities; an information type determination unit which determines an information type used in the new workflow; a degree-of-similarity determination unit which determines a degree of similarity between the information type used in the new workflow and the information type used in the existing workflow; and a workflow extraction unit which extracts an existing workflow having the degree of similarity equal to or greater than a predetermined value.

According to a second aspect of the invention, a workflow handling method in a workflow handling apparatus includes: storing various activities as processing units forming a workflow, in an activity storage unit; storing information about an existing workflow including each of the activities, in a workflow configuration storage unit; storing data on an information type used in the existing workflow, in an information type storage unit; storing, in a request storage unit, a new workflow created on the basis of a processing request to the workflow handling apparatus, the new workflow being connected with a processing corresponding to the various activities; determining an information type used in the new workflow by an information type determination unit; determining a degree of similarity between the information type used in the new workflow and the information type used in the existing workflow by a degree-of-similarity determination unit; and extracting an existing workflow having the degree of similarity equal to or greater than a predetermined value by a workflow extraction unit.

According to a third aspect of the invention, an image forming apparatus includes: a data acquisition unit which acquires document data to be a processing target of a workflow; an activity storage unit which stores various activities as processing units forming a workflow; a workflow configuration storage unit which stores information about an existing workflow including each of the activities; an information type storage unit which stores data on an information type used in the existing workflow; a workflow execution unit which forms the activity based on the information about the workflow stored in the workflow storage unit and executes processing of the acquired document data; a request storage unit which stores a new workflow created on the basis of a processing request to the workflow handling apparatus, the new workflow being connected with a processing corresponding to the various activities; an information type determination unit which determines an information type used in the new workflow; a degree-of-similarity determination unit which determines a degree of similarity between the information type used in the new workflow and the information type used in the existing workflow; and a workflow extraction unit which extracts an existing workflow having the degree of similarity equal to or greater than a predetermined value. The information about the workflow includes information specifying each activity that forms the workflow and information about an execution order of each activity.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 shows the configuration of a workflow system according to a first embodiment of the invention.

FIG. 2 shows a table structure representing information types for each workflow.

FIG. 3 shows an example of utilizing a UML diagram.

FIG. 4 shows a table structure representing determined information types.

FIG. 5 shows the configuration of a workflow system according to a second embodiment.

FIG. 6 shows a screen for assisting a designer.

FIG. 7 shows the configuration of a workflow system according to a third embodiment.

FIG. 8 shows a screen for assisting a designer.

FIG. 9 is a perspective view showing the appearance of an MFP.

### DETAILED DESCRIPTION

Hereinafter, the configuration and operation of workflow system according to embodiments of the invention will be described, using an example of processing in which a digital multifunction peripheral is used to scan a paper document, then form electronic data and analyze a document image. However, the invention is not limited to this example of processing.

### First Embodiment

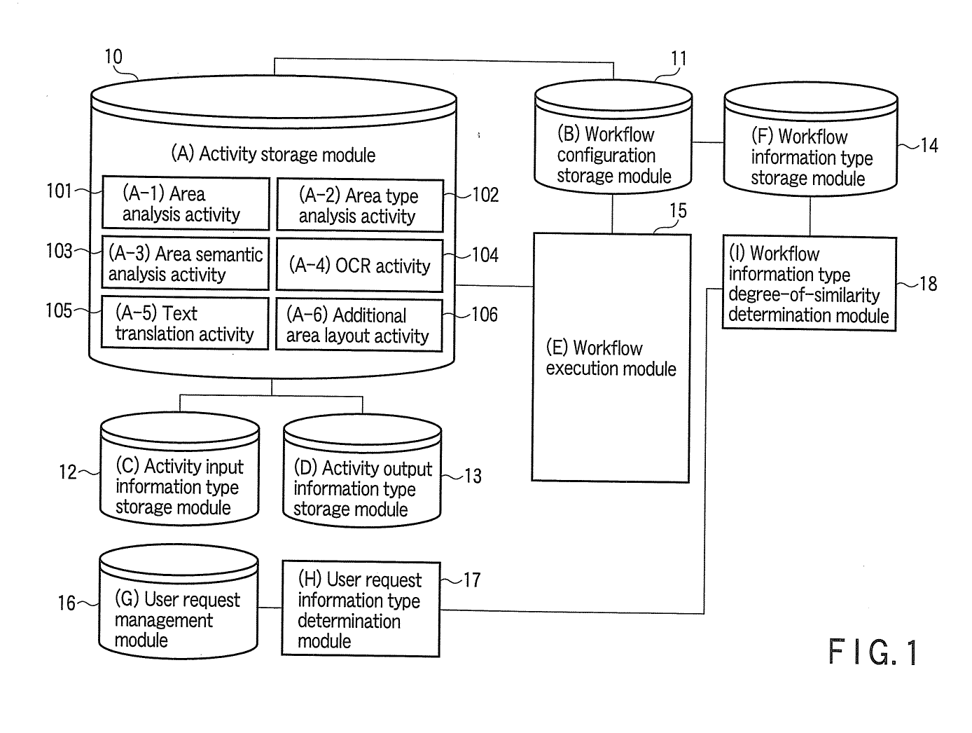

FIG. 1 shows the configuration of a workflow system according to a first embodiment of the invention.

The workflow system is provided with an activity storage module 10, a workflow configuration storage module 11, an activity input information type storage module 12, an activity output information type storage module 13, a workflow information type storage module 14, and a workflow execution module 15.

The workflow system further includes a user request management module 16, a user request information type determination module 17, and a workflow information type degree-of-similarity determination module 18.

The activity storage module 10 stores various activities as processing forming units of a workflow when executing a processing to a document by using the workflow. For example, the activity storage module 10 stores an area analysis activity 101, an area type analysis activity 102, an area semantic analysis activity 103, an OCR activity 104, a text translation activity 105, and an additional area layout activity 106.

In the area analysis activity 101, “page image information” of a document is inputted and rectangular areas such as pixel blocks in an image are determined. Then, “area coordinate information” and “area image information” of the rectangular areas are outputted. In the area type analysis activity 102, the “area image information” of the rectangular areas is inputted and whether the rectangular areas include character strings or not is determined on the basis of analysis of distribution of pixels in the areas and so on. Then, “area type information” of the rectangular areas is outputted.

In the area semantic analysis activity 103, the “area coordinate information” and the “area type information” of the rectangular areas are inputted and area semantics such as title, date or the like is determined from the layout of the areas in the page. Then, “area semantic information” of the rectangular areas is outputted. In the OCR activity 104, the “area image information” of a rectangular area with the value of “area type information” indicating a character string is inputted and character recognition is performed with respect to this rectangular area. Then, “area text information” is outputted. In the text translation activity 105, the “area text information” is inputted and machine translation is performed with respect to the text in a specified language. Then, “area different-language text information” is outputted.

In the additional area layout activity 106, the “area text information” as the output of the OCR activity 104 and the “area different-language text information” as the output of the text translation activity 105 are inputted. Moreover, in the additional area layout activity 106, the “area coordinate information” as the output of the area analysis activity 101 and the “area semantic information” as the output of the area type analysis activity 102 are inputted.

Then, in the additional area layout activity 106, new page image information is laid out using additional information including a different-language text as an additional area. “Additional area coordinate information” to arrange the additional area in the “page image information” or to replace the “page image information” with the additional area is outputted.

The workflow configuration storage module 11 stores information about the workflow formed by each activity stored in the activity storage module 10. The information stored in this case includes information specifying each activity, information about the execution order of each activity, workflow name and so on.

The activity input information type storage module 12 stores information about information type inputted to each activity. For example, in the case of the area analysis activity 101, information is stored which indicates that “page image information” is inputted.

The activity output information type storage module 13 stores information about information type outputted from each activity. For example, in the case of the area analysis activity 101, information is stored which indicates that “area coordinate information” and “area image information” are outputted.

The workflow information type storage module 14 stores information about the information type used by each of the activities that forms the workflow stored in the workflow configuration storage module 11.

The workflow execution module 15 forms and executes activities in accordance with the information stored in the workflow configuration storage module 11.

The workflow system according to the first embodiment further includes the user request management module 16, the user request information type determination module 17 and the workflow information type degree-of-similarity determination module 18.

The user request management module 16 stores a series of user requests to this system. For example, a user's request to “scan a paper document and save the document in a minimum possible file size” is stored in the form of “use case 1: carry out high-compression file creation scan” by a person responsible for designing the workflow.

The user request information type determination module 17 determines the information type that is necessary for a processing to satisfy that use case. For example, in response to the “use case 1: carry out high-compression file creation scan,” the user request information type determination module 17 determines that the information type necessary for a workflow to satisfy that request includes “page image information,” “area coordinate information,” “area image information” and “area type information.” The result of this determination is stored in the workflow information type storage module 14.

The workflow information type degree-of-similarity determination module 18 calculates the degree of similarity between the information type determined by the user request information type determination module 17 and the existing workflow information type stored in the workflow information type storage module 14.

An “activity” refers to an aggregate of software having a predetermined granularity to realize the processing of a workflow. A “module” refers to a program and database to manage and store activities and various information involved in the activities in this system, and to design an activity based on the various information.

In FIG. 1, rectangular block represent programs and activities, and cylindrical blocks represent databases. Lines connecting modules indicate that data including an activity is communicated or that there is a connection between data.

Next, the operation of this workflow system will be described.

In this workflow system as described above, an activity corresponding to each processing is stored in the activity storage module 10.

Each activity has the information type of input that is necessary for a processing and the information type of output as a result of the processing, in accordance with the content of the processing. The information types of input and output are managed in the activity input information type storage module 12 and the activity output information type storage module 13.

As for a created workflow, input and output data of each activity which forms the workflow are managed in the workflow information type storage module 14 and can be referred to in accordance with the workflow.

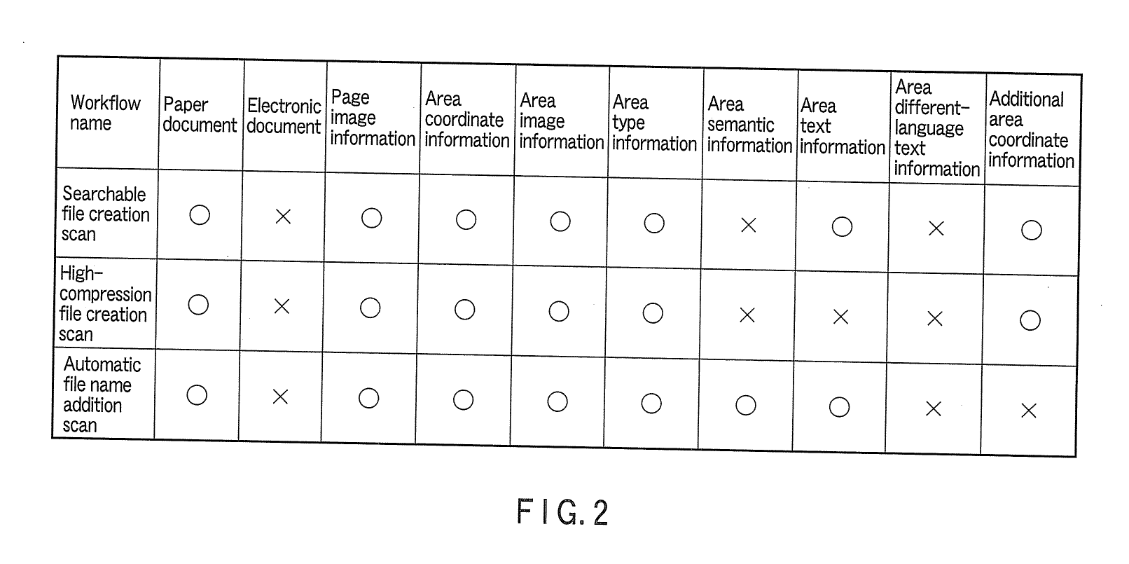

FIG. 2 shows a table structure representing an information type for each workflow. This table is stored in the workflow information type storage module 14.

In this table, a type of information necessary for each workflow (information type) is described. A necessary information type is indicated by “O”. An unnecessary information type is indicated by “X”. These information types correspond to installed activities. Therefore, if a new activity is added, a new information type section is added to this table.

As these activities are formed in this manner, a workflow to execute a series of processings corresponding to a specific purpose can be constructed. The workflow execution module 15 can operate the workflow.

That is, the workflow execution module 15 extracts an activity stored in the activity storage module 10 with reference to the information stored in the workflow configuration storage module 11. The workflow execution module 15 then delivers processing information in accordance with the input and output information types of each activity stored in the workflow information type storage module 14 and executes the activity in accordance with the stored order information.

Next, a design assisting operation at the time of creating and adding a new workflow to this workflow system will be described. Here, an operation to assist in designing a workflow where there is a user's request to the workflow system to “translate the content written in a paper document into English and print the content on a paper,” will be described.

In response to such a user request, the workflow designer utilizes an object-oriented design and development technique using a UML (Unified Modeling Language) diagram. In the method for design and development assistance of this case, the object-oriented design and development technique is utilized at the time of describing the functions to be realized by the workflow.

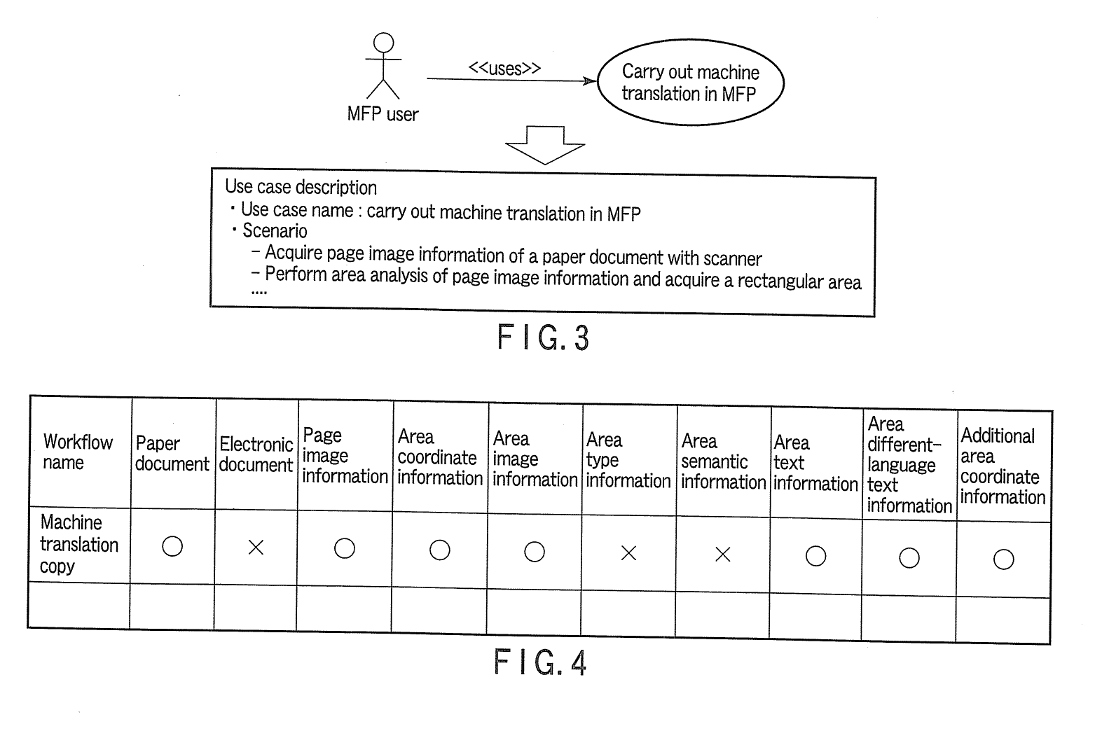

FIG. 3 shows an example of utilizing a UML diagram.

In the utilization of a UML diagram, a use case diagram is created. A use case diagram refers to a diagram in which a function requested of the system is drawn from the user's perspective. In FIG. 3, the MFP (multifunction peripheral) user requests a function of “carrying out machine translation in MFP” from the system.

In a request analysis technique using a general use case diagram, a scenario of processing corresponding to this use case is described. In FIG. 3, a scenario including “acquire page image information of a paper document with scanner” is described with respect to the above use case.

Similarly, in this workflow system, for this user request, the workflow designer describes “use case 2: carry out machine translation in MFP” as a use case of the system.

The workflow designer then dissolves the scenario and designs a workflow so that processing units (activities) having a granularity of a predetermined processing aggregate are connected. That is, the designer makes an analysis such as “2-1: scan and acquire page image information of a paper document,” “2-2: perform area analysis of the page image information and acquire a rectangular area,” “2-3: determine an area type of the rectangular area and extract a character string area,” “2-4: perform OCR to the character string area and acquire area text information,” “2-5: carry out machine translation of the area text and acquire text information in a different language,” and “2-6: properly lay out the text information in the different language in a state of being capable of corresponding to the layout of the page image area in the original language.”

The request thus described as a use case by the designer is stored in the “(G) user request management module 16.”

Meanwhile, for each of the processing units (activities) of the scenario, there is an information type of input and an information type of output as a result of processing. The user request information type determination module 17 determines the associated information types from the scenario acquired by analyzing the user request.

For example, with respect to the above “2-2: perform area analysis of the page image information and acquire a rectangular area,” dissolved as the scenario of the use case, the user request information type determination module 17 determines that the information type of input that is necessary for processing is the “page image information” acquired by scanning the paper document or the like, and that the information type of output as a result of processing is the “area coordinate information” and “area image information.”

Information types necessary for a workflow with respect to a new use case are determined in this manner. FIG. 4 shows a table structure representing determined information types. These information types determined by the user request information type determination module 17 can be managed in a table structure similar to the table structure of information types in the existing workflow shown in FIG. 2.

Next, the designer needs to repeatedly carry out a work of determining whether the created workflow and the created information type properly represent the user request or not, then making proper modifications and designating a workflow and an information type that necessary for the workflow. However, this work requires skills and a mechanism for efficiently carrying out this work is desired.

Thus, this system has the function of assisting in designing a workflow. That is, the workflow information type degree-of-similarity determination module 18 determines whether any of the existing workflows handles a similarity information type with respect to this new use case or not.

If what information types are used by the existing workflows is shown in the table structure of FIG. 2, this information can be expressed by a vector. For example, if an information type is necessary (indicated by “O” in the table of FIG. 2), a value 1 is used. If an information type is not necessary (indicated by “X” in the table of FIG. 2), a value 0 is used.

According to this method, for example, for a workflow “searchable file creation scan,” the information about information types can be expressed by a vector of (1, 0, 1, 1, 1, 1, 0, 1, 0, 1). For a workflow “high-compression file creation scan,” the information about information types can be expressed by a vector (1, 0, 1, 1, 1, 1, 0, 0, 0, 1).

Moreover, information types required by a new use case “machine translation copy” are represented in a table structure as shown in FIG. 4, by the user request information type determination module 17. Thus, the information about the information types can be expressed by a vector (1, 0, 1, 1, 1, 0, 0, 1, 1, 1).

Next, an approximation between these vectors is found. The approximation is calculated by taking a coefficient of correlation between the two vectors. The coefficient of correlation of the vectors is found as a cosine component of an angle at which the two vectors intersect each other. The formula for finding the coefficient of correlation between the vectors is a known formula and therefore will not be described further in detail.

The coefficient of correlation found from the information type vectors of the existing workflow “searchable file creation scan” and the new workflow “machine translation copy” is about 0.52. The coefficient of correlation found from the information type vectors of the existing workflow “high-compression file creation scan” and the new workflow “machine translation copy” is about 0.36.

If the coefficient of correlation has a value close to 1, the information types of the combination are similar to each other. That is, it can be determined that the two workflows are similar to each other. Therefore, in this example, it can be determined that the workflow “searchable file creation scan” is more similar to the workflow “machine translation copy” than the other workflow is.

The workflow information type degree-of-similarity determination module 18 thus extracts workflows having a coefficient of correlation that is equal to or greater than a predetermined value, and presents the extracted workflows to the designer. The workflow designer can receive recommendation of an existing similar workflow from the system which the designer can refer to, in dealing with a new use request. The configuration of such a recommended existing workflow can be referred to by searching the workflow configuration storage module 11. Therefore, by receiving the presentation of the configuration, the workflow designer can easily create a new workflow.

### Second Embodiment

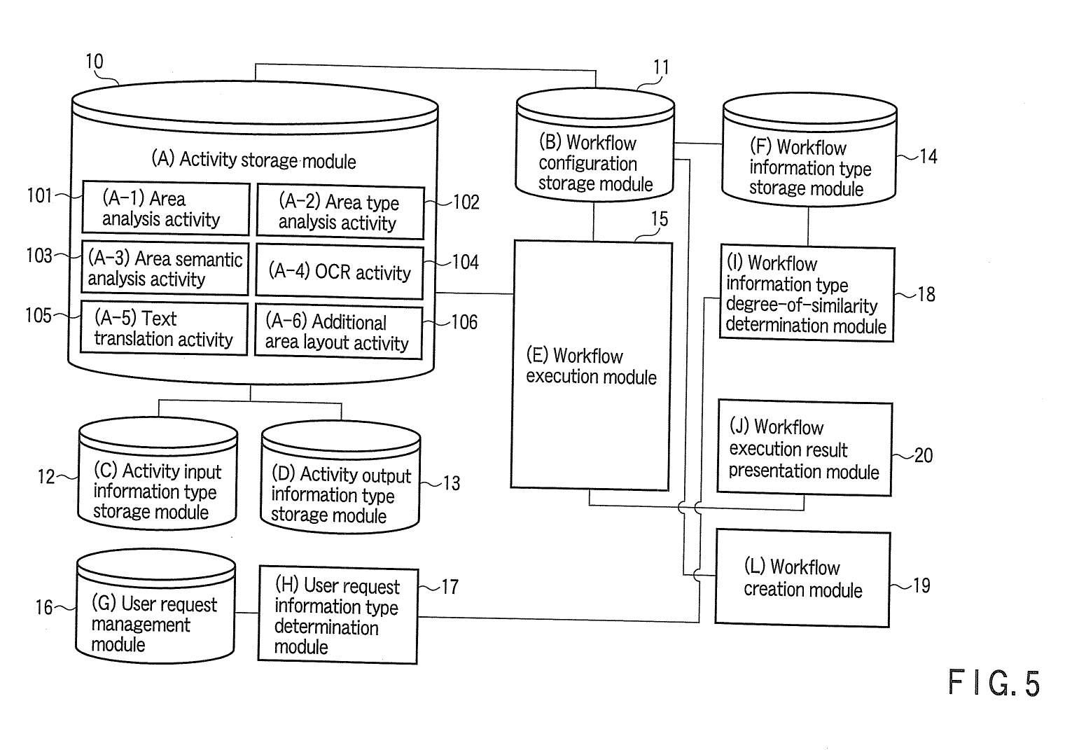

FIG. 5 shows the configuration of a workflow system according to a second embodiment. The second embodiment differs from the first embodiment in that a workflow creation module 19 and a workflow execution result presentation module 20 are added as components. Therefore, the same parts as in the first embodiment are denoted by the same reference numerals and will not be described further in detail.

The workflow creation module 19 creates information about a workflow designated by a user, of new workflows extracted in the first embodiment, and stores the information in the workflow configuration storage module 11. The workflow creation module 19 stores the type of information used in that workflow in the workflow information type storage module 14.

Moreover, the workflow creation module 19 creates information about a workflow designed via a GUI on the basis of a new workflow extracted in the first embodiment and stores the information in the workflow configuration storage module 11. The workflow creation module 19 stores the type of information used in the designed workflow in the workflow information type storage module 14.

The workflow execution result presentation module 20 presents the result of a workflow executed by the workflow execution module 15 to the workflow designer. The presented result may be the result of execution of an actually designed workflow or may be the result of execution of a workflow recommended to the designer by the workflow information type degree-of-similarity determination module 18 in the stage of designing the workflow as described in the first embodiment, and a workflow that is newly created on the basis of the recommended workflow.

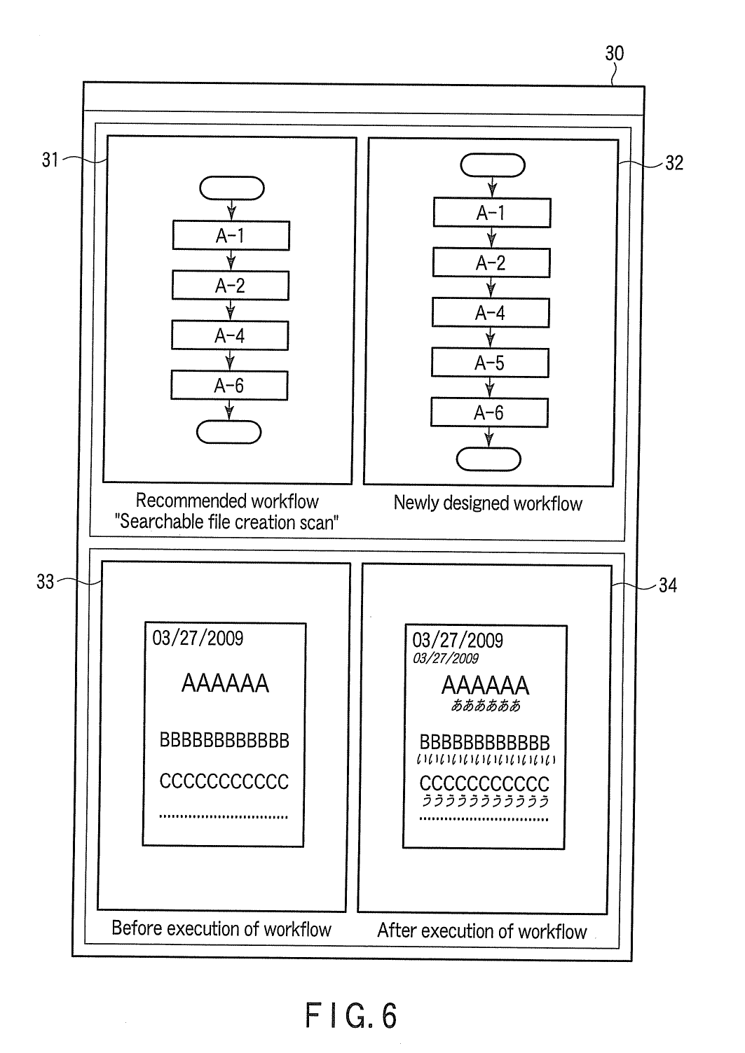

FIG. 6 shows a screen 30 for assisting the designer in dealing with the use case 2 (carry out machine translation in MFP) of the first embodiment.

The screen 30 shows four areas, that is, an area 31 to an area 34. The workflow execution result presentation module 20 is installed as an application having a GUI and displays “page image information” before the execution of a workflow, in the area 33. The workflow execution result presentation module 20 then displays image information in which “additional area coordinate information” as the result of the execution of the workflow is added onto the original “page image information,” in the area 34.

The “page image information” before the execution of the workflow, displayed in the area 33, is an image of a document described in American English. The title, the text, and the date in the header part are described according to the notation of American English. In the “page image information” after the execution of the workflow displayed in the area 34, the “area text information” translated to Japanese as a different language and that of the American English notation are associated with each other. The foregoing takes place because the additional area layout activity 106 outputs the “additional area coordinate information” for arranging a layout that enables easy reference and the workflow execution result presentation module 20 presents image information based on the outputted information.

The workflow execution result presentation module 20 also displays the configuration of a workflow stored in the workflow configuration storage module 11, in the area 31. As the display of the workflow configuration, not only the activity configuration of an existing workflow recommended to the workflow designer can be displayed but also the activity configuration of a new workflow created by the workflow designer on the basis of the recommended existing workflow can be simultaneously displayed in the area 32. In the area 34, the result of execution of the new workflow may be displayed.

As the workflow execution result presentation module 20 displays information as in the screen 30, the workflow designer can easily confirm the actual activity configuration and the result of execution of the workflow based on that configuration and can enhance the efficiency of designing work.

### Third Embodiment

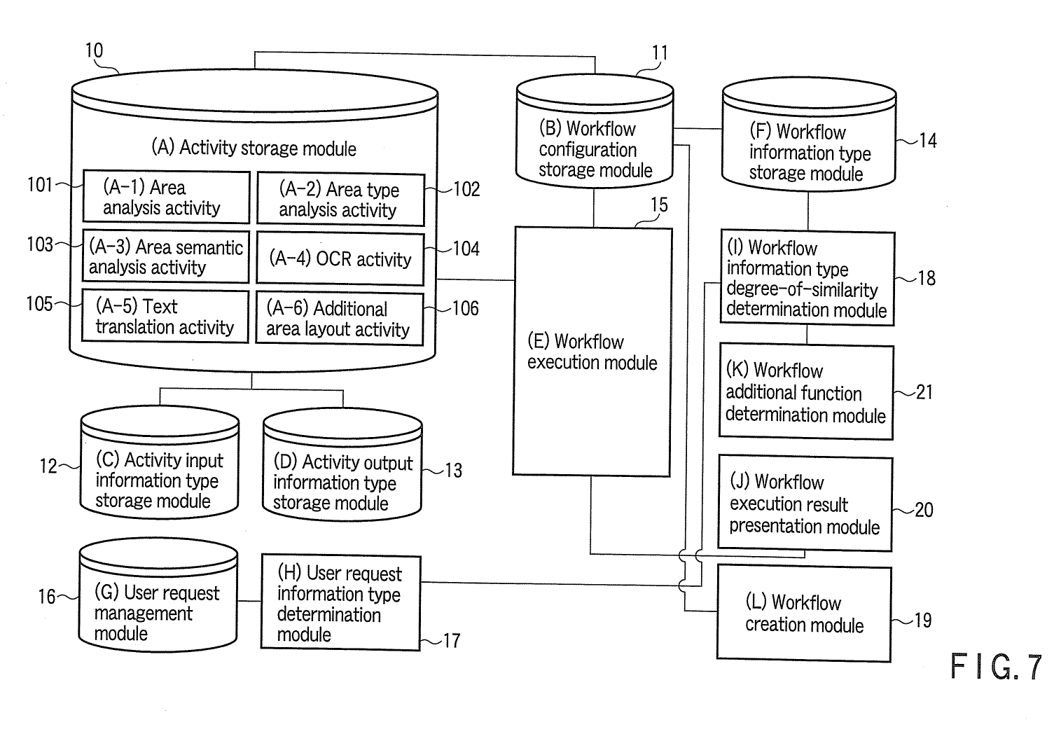

FIG. 7 shows the configuration of a workflow system according to a third embodiment. The third embodiment differs from the second embodiment in that a workflow additional function determination module 21 is added as a component. Therefore, the same parts as in the second embodiment are denoted by the same reference numerals and will not be described further in detail.

Taking the processes as described in the first and second embodiments, the workflow designer can efficiently design a workflow in response to a new user request. However, the workflow designer not only can design a workflow that satisfies the user request but also can create a workflow of increased value by adding a new function. In the third embodiment, a method of creatively adding a new function in workflow design will be described.

In the result of the execution of the workflow in the designing stage shown in the area 33 of FIG. 6, described in the second embodiment, the rectangular character area described to the upper left of the “page image information” before the execution of the workflow is simply a character area and the result of OCR is numbers. Therefore, the text translation activity 105 outputs an array of numbers as “area different-language text information.” However, the character area of interest in the “page image information” in this example is a character string indicating the date described in the header part. This fact can be determined by applying a predefined rule that if numbers are arrayed in a specific way of arrangement in the header part in a general document page, the numbers indicate the date.

To determine that the numbers indicate the date, “area semantic information” outputted by the area semantic analysis activity 103 after analyzing the semantics of the area, and “area text information” outputted by the OCR activity 104 after performing OCR processing can be used. That is, this determination can be made by applying a rule that a character sting of numbers having a specific number of digits outputted as a header in the “area semantic information” indicates the date.

In this manner, as an existing workflow utilizing “area semantic information,” the workflow “automatic file name addition scan” can be extracted with reference to the table shown in FIG. 2. This workflow “automatic file name addition scan” is a workflow that utilizes “area text information” in the area outputted as being a title in the “area semantic information,” as a file name.

Meanwhile, the coefficient of correlation between this workflow “automatic file name addition scan” and the workflow “machine translation copy” calculated by the workflow information type degree-of-similarity determination module 18 is about 0.05. It is determined that the degree of similarity is low. Therefore, the workflow “automatic file name addition scan” is not recommended to the workflow designer.

However, even for a function of a workflow having degree of similarity that is not very high, the workflow additional function determination module 21 presents the function as an applicable additional function if a predetermined condition is met. Thus, a workflow that is not considered by the workflow designer can be created.

In determining whether to present a function as an additional function or not, the workflow information type stored in the workflow information type storage module 14 is utilized. In the existing workflow “automatic file name addition scan”, “area semantic information” is utilized. However, in order to output this “area semantic information,” “area coordinate information” and “area type information” need to be inputted to the area semantic analysis activity 103.

Similarly, “area coordinate information” and “area type information” are already utilized in the new workflow “machine translation copy” as well. Therefore, the workflow additional function determination module 21 determines that “area semantic information” can be acquired by adding the area semantic analysis activity 103 in the workflow “machine translation copy.”

The workflow additional function determination module 21 presents the configuration information of the existing workflow that is determined in this way, to the workflow designer via the workflow execution result presentation module 20, and thus can offer an opportunity to add a function that is not considered by the designer to the workflow.

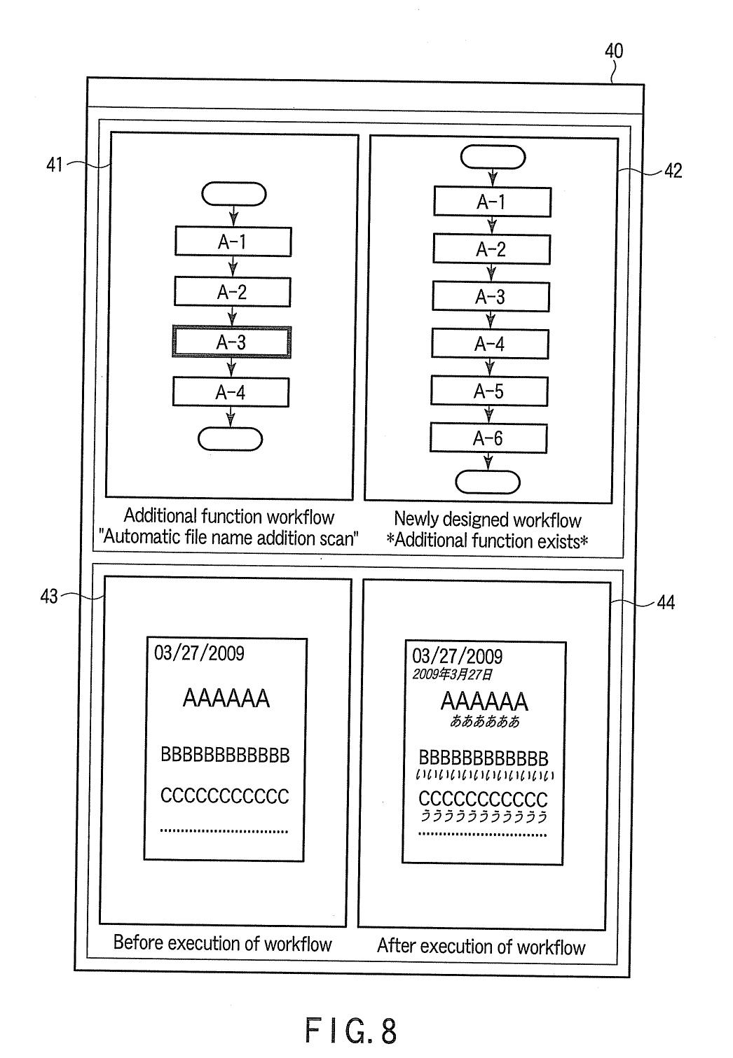

FIG. 8 shows a screen 40 for assisting the designer in dealing with the use case 2 of the first embodiment.

The screen 40 shows four areas, that is, an area 41 to an area 44. The workflow execution result presentation module 20 is installed as an application having a GUI and displays “page image information” before execution of a workflow in the area 43. The workflow execution result presentation module 20 then displays image information in which “additional area coordinate information” as a result of the execution of the workflow is added onto the original “page image information,” in the area 44.

Moreover, for example, a workflow “automatic file name addition scan” is displayed in the area 41 as a workflow determined as being a reference for the addition of a function. The additional function of interest is shown in a recognizable manner. For example, an activity (A-3) equivalent to the additional function of interest is highlighted by changing color, luminance and so on. Thus, the presence of the additional function is explicitly presented to the workflow designer.

In the area 42, a new workflow designed by the designer in accordance with this presentation is displayed. In the area 44, the result of output after the execution of the newly designed workflow having (A-3) added as an activity is reflected in the display.

In the newly designed workflow, as such a function is added, if a character string indicating the date is handled, the language dependence in the notation can be applied to properly translate the character string in the text translation activity 105. In this example, a character string indicating the date “03/27/2009” in American English describes Mar. 27, 2009. Therefore, as “area different-language text information” as a result of the translation of the area of interest, “2009/03/27” or “Year 2009, Mar. 27” is outputted, which is common in Japanese.

The workflow systems of the above embodiments can be incorporated in a digital multifunction peripheral (MFP).

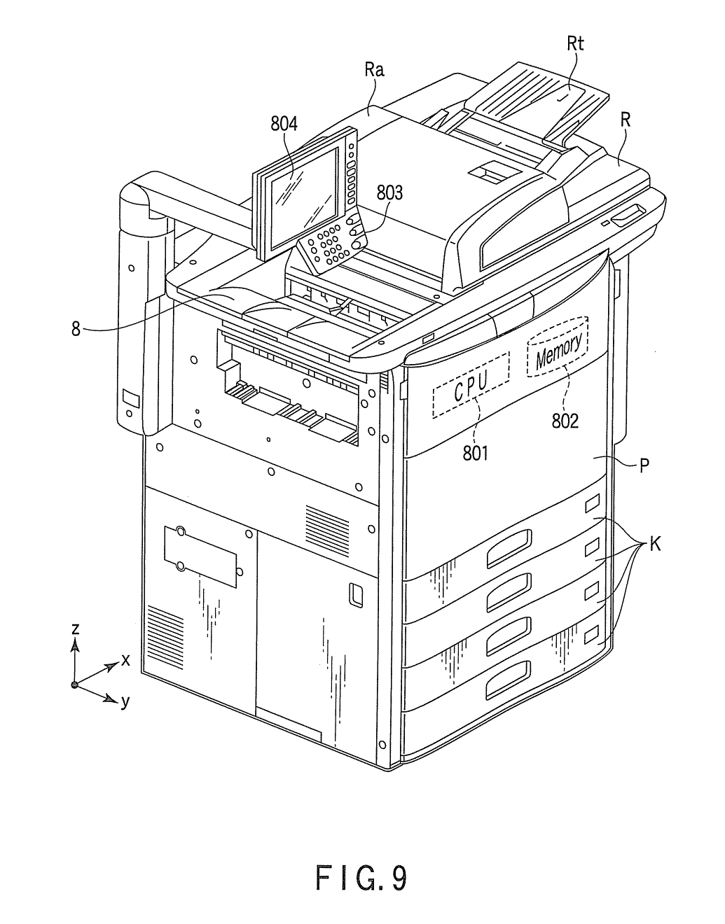

FIG. 9 is a perspective view showing the appearance of an MFP 1.

The MFP 1 has an automatic document feeder Ra, an image scanning unit R, an image forming unit P, a discharge tray 8, a CPU 801, a memory 802, an operation input unit 803, and a display unit 804.

The automatic document feeder (ADF) Ra has a function of continuously and automatically feeding plural sheets of documents placed on a tray Rt toward a predetermined position of document scanning by the image scanning unit R.

The image scanning unit R is arranged in an upper part of the body of the MFP 1 and has a function of scanning and reading an image of a sheet document that is automatically fed by the automatic document feeder Ra or a sheet document or book document placed on a document table, not shown.

The image forming unit P has a function of forming a developer image on a sheet supplied from a paper supply cassette K on the basis of the image scanned from the original by the image scanning unit R or image data or the like received by the MFP 1 from an external device.

The sheet on which an image is formed by the image forming unit P is discharged onto the discharge tray 8.

The CPU 801 is responsible for performing various processing in the MFP 1 and also responsible for executing programs stored in the memory 802 and thereby realizing various functions. The memory 802 can include, for example, a RAM (random access memory), ROM (read only memory), DRAM (dynamic random access memory), SRAM (static random access memory), VRAM (video RAM) or the like. The memory 802 is responsible for storing various information and programs used in the MFP 1.

The operation input unit 803 can include, for example, a keyboard, mouse, touch panel, touchpad, graphics tablet or the like.

The display unit 804 can include, for example, an LCD (liquid crystal display), EL (electro-luminescence), PDP (plasma display panel), CRT (cathode ray tube) or the like.

Moreover, a so-called touch panel display can realize the functions of the operation input unit 803 and the display unit 804.

The above modules may be saved in the memory 802. As programs are properly executed by the CPU 801, the workflow systems of the above embodiments can be operated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A workflow handling apparatus comprising:
an activity storage unit which stores various activities as processing units forming a workflow;
a workflow configuration storage unit which stores information about an existing workflow including each of the activities;
an information type storage unit which stores data on an information type used in the existing workflow;
a request storage unit which stores a new workflow created on the basis of a processing request to the workflow handling apparatus, the new workflow being connected with a processing corresponding to the various activities;
an information type determination unit which determines an information type used in the new workflow;
a degree-of-similarity determination unit which determines a degree of similarity between the information type used in the new workflow and the information type used in the existing workflow; and
a workflow extraction unit which extracts an existing workflow having the degree of similarity equal to or greater than a predetermined value.

2. The apparatus according to claim 1, wherein the degree-of-similarity determination unit calculates a coefficient of correlation between a first data vector representing whether each information type used in each of the activities is used in the new workflow or not and a second data vector representing whether each information type used in each of the activities is used in the existing workflow or not, and determines the degree of similarity.

3. The apparatus according to claim 1, further comprising a workflow execution unit which forms the activity based on the information about the workflow stored in the workflow configuration storage unit and executes processing of document data,
wherein the information about the workflow include information specifying each activity that forms the workflow and information about an execution order of each activity.

4. The apparatus according to claim 3, further comprising a workflow creation unit which creates information about the new workflow, stores the information in the workflow configuration storage unit, and stores information about an information type used in the new workflow in the information type storage unit, and which creates information about a workflow designed via a user interface on the basis of the extracted existing workflow, stores the information in the workflow configuration storage unit, and stores information about an information type used in the designed workflow in the information type storage unit.

5. The apparatus according to claim 4, further comprising a workflow execution result presentation unit which edits and displays the document data as a processing target, a diagram showing a configuration of a workflow to be executed by the workflow execution unit, and document data as a result of executing the workflow, in one screen.

6. The apparatus according to claim 5, wherein the workflow to be executed by the workflow execution unit includes the extracted existing workflow, the new workflow and the designed workflow.

7. The apparatus according to claim 3, further comprising an additional function determination unit which, when a predetermined information type among types of information used in the new workflow coincides with a predetermined information type in a specific existing workflow stored in the information type storage unit, extracts the specific existing workflow as an additional workflow.

8. The apparatus according to claim 7, further comprising a workflow creation unit which creates information about the additional workflow, stores the information in the workflow configuration storage unit, and stores information about an information type used in the additional workflow in the information type storage unit, and which creates information about a workflow designed via a user interface on the basis of the additional workflow, stores the information in the workflow configuration storage unit, and stores information about an information type used in the designed workflow in the information type storage unit.

9. The apparatus according to claim 8, further comprising a workflow execution result presentation unit which edits and displays the document data as a processing target, a diagram showing a configuration of a workflow to be executed by the workflow execution unit, and document data as a result of executing the workflow, in one screen.

10. The apparatus according to claim 9, wherein the workflow to be executed by the workflow execution unit includes the additional workflow and the designed workflow.

11. A workflow handling method in a workflow handling apparatus comprising:
storing various activities as processing units forming a workflow, in an activity storage unit;
storing information about an existing workflow including each of the activities, in a workflow configuration storage unit;
storing data on an information type used in the existing workflow, in an information type storage unit;
storing, in a request storage unit, a new workflow created on the basis of a processing request to the workflow handling apparatus, the new workflow being connected with a processing corresponding to the various activities;
determining an information type used in the new workflow by an information type determination unit;
determining a degree of similarity between the information type used in the new workflow and the information type used in the existing workflow by a degree-of-similarity determination unit; and
extracting an existing workflow having the degree of similarity equal to or greater than a predetermined value by a workflow extraction unit.

12. The method according to claim 11, wherein the degree-of-similarity determination unit calculates a coefficient of correlation between a first data vector representing whether each information type used in each of the activities is used in the new workflow or not and a second data vector representing whether each information type used in each of the activities is used in the existing workflow or not, and determines the degree of similarity.

13. The method according to claim 11, wherein the activity is formed on the basis of the information about the workflow stored in the workflow configuration storage unit and processing of document data is executed by a workflow execution unit, and
the information about the workflow include information specifying each activity that forms the workflow and information about an execution order of each activity.

14. The method according to claim 13, wherein by a workflow creation unit provided in the workflow handling apparatus:
information about the new workflow is created and stored in the workflow configuration storage unit and information about an information type used in the new workflow is stored in the information type storage unit; and information about a workflow designed via a user interface on the basis of the extracted existing workflow is crated and stored in the workflow configuration storage unit and information about an information type used in the designed workflow is stored in the information type storage unit.

15. The method according to claim 14, wherein the document data as a processing target, a diagram showing a configuration of a workflow to be executed by the workflow execution unit, and document data as a result of executing the workflow are edited and displayed in one screen by a workflow execution result presentation unit.

16. The method according to claim 12, wherein when a predetermined information type among types of information used in the new workflow coincides with a predetermined information type in a specific existing workflow stored in the information type storage unit, the specific existing workflow is extracted as an additional workflow by an additional function determination unit.

17. The method according to claim 16, wherein by a workflow creation unit provided in the workflow handling apparatus:
information about the additional workflow is created and stored in the workflow configuration storage unit and information about an information type used in the additional workflow is stored in the information type storage unit; and information about a workflow designed via a user interface on the basis of the additional workflow is created and stored in the workflow configuration storage unit and information about an information type used in the designed workflow is stored in the information type storage unit.

18. The method according to claim 17, wherein the document data as a processing target, a diagram showing a configuration of a workflow to be executed by the workflow execution unit, and document data as a result of executing the workflow are edited and displayed in one screen by a workflow execution result presentation unit.

19. An image forming apparatus comprising:
a data acquisition unit which acquires document data to be a processing target of a workflow;
an activity storage unit which stores various activities as processing units forming a workflow;
a workflow configuration storage unit which stores information about an existing workflow including each of the activities;
an information type storage unit which stores data on an information type used in the existing workflow;
a workflow execution unit which forms the activity based on the information about the workflow stored in the workflow configuration storage unit and executes processing of the acquired document data;
a request storage unit which stores a new workflow created on the basis of a processing request to the image forming apparatus, the new workflow being connected with a processing corresponding to the various activities;
an information type determination unit which determines an information type used in the new workflow;
a degree-of-similarity determination unit which determines a degree of similarity between the information type used in the new workflow and the information type used in the existing workflow; and
a workflow extraction unit which extracts an existing workflow having the degree of similarity equal to or greater than a predetermined value;
wherein the information about the workflow includes information specifying each activity that forms the workflow and information about an execution order of each activity.

20. The apparatus according to claim 19, wherein the degree-of-similarity determination unit calculates a coefficient of correlation between a first data vector representing whether each information type used in each of the activities is used in the new workflow or not and a second data vector representing whether each information type used in each of the activities is used in the existing workflow or not, and determines the degree of similarity.
